(19) United States
(12) Patent Application Publication
(10) Pub. No.: US 2006/0010082 A1
(43) Pub. Date: Jan. 12, 2006

(54) Product and pricing term updates

(76) Inventors: Karen A. Gee, Heidelberg (DE); Klaus Kohlmaier, Leimen (DE)

Correspondence Address: KENYON & KENYON, ONE BROADWAY, NEW YORK, NY, 10004, US

(21) Appl. No.: 11/026,097

(22) Filed: Jan. 3, 2005

Related U.S. Application Data
(60) Provisional application No. 60/585,593, filed on Jul. 7, 2004.

(51) Int. Cl. G06F 17/00

(52) U.S. Cl. 705/400

(57) ABSTRACT

A product and pricing term updating system accessed a contract database storing contracts with product and pricing terms. A processing device retrieves the product and pricing terms nearing expiration and generates a procurement form that includes the product and pricing terms to be updated. The processing device may convert the form into a format to be accessible using an electronic mail delivery system and provide the procurement form to an output device. The electronic message may then be electronically transmitted to the parties to the contract, providing an automatic reminder that specifically noted product and pricing terms are subject to expiration. The procurement form allows for the renewal or renegotiations of the product and pricing terms. The parties renegotiate these terms, update the procurement form and provide the procurement form back to the processing device. The updated product and pricing terms are therein stored back in the contract database.

### BACKGROUND

The present invention relates generally to the area of software and more specifically to the maintenance of product and pricing information in a database.

Currently, problems arise in maintaining electronic documentation of product and pricing information relating to purchase contracts. In a typical approach, purchase contracts include multiple contract terms relating to varying aspects of the sales agreement between a purchaser and a supplier, including terms relating to specific product information and corresponding pricing information. In negotiated contracts, product and price terms are applicable for a defined period of time. In other instances, external conditions may arise requiring a party to seek adjustments of product and pricing terms.

Problems arise in the maintenance of multiple contracts having various product and pricing terms with different expiration dates, wherein the expiration date is the date on which the product and/or pricing terms are deemed to expire. With multiple contracts and multiple product and pricing terms, it is easy for terms to expire accidentally. Therefore, oversight is required insure all purchase contracts contain current terms.

In a typical purchaser/supplier contract, there exists numerous contract terms defining the business relationship on all levels. It is not uncommon for a contract to include hundreds of contract terms relating to product and pricing information. For example, one common sales technique includes volume discounting where a product is offered for a reduced price per/unit based on an increase in volume. Multiple sales positions may exist for all levels of the tiered pricing, so a single product in a sales contract may include an extensive number of product and pricing terms. Adding in various differences between different versions of the same product, for example different sizes of a particular item, further increases the number of contract terms in a sales contract.

A current approach is to note expiration dates manually for the product and pricing terms in the actual contract. A common technique is to establish the expiration date of these terms at a time coordinating with renegotiations of the contract. For example, the sales contract may be negotiated for a six-month interval, whereupon after six months, the purchaser and supplier must renegotiate the contract and reach an agreement on a new set of contract terms.

The current approach is problematic when dealing with a large number of contracts having multiple product and pricing terms. Furthermore, unless the parties to contract record the expiration dates on a calendar or in an electronic calendar software application, problems can arise from parties accidentally letting these terms expire. Furthermore, this approach requires not only the negotiation of the contract, but then the further manual step of recording the expiration date(s) for the product and pricing terms. As noted above, in a typical purchase agreement, the number of terms can make this process extremely time-consuming for the purchaser and the supplier and also susceptible to human input errors.

Furthermore, with the growth of computing systems and automated processes, the current approach fails to take advantage of benefits offered by computing operations. While many contracts are negotiated in-person between a supplier and purchaser, a growing trend includes paperless negotiations. As electronic contracts include numerous product and pricing terms, it can become even more difficult to maintain an accurate and proper record of expiration dates of these terms when the contract is negotiated using electronic only forms because of a lack of an expiration date monitoring system.

Another problem arises regarding software integration requirements for electronic systems. An individual supplier works with many purchasers and vice versa. These different parties engage in many different contracts. Often times, different suppliers and vendors use different software applications. Therefore, problems arise in congruency of electronic documentation across multiple vendor-specific systems. Parties are also reluctant to acquire new software products outside of their own due to costs, maintenance, training and compatibility issues.

A current contract database system utilizes a host application granting user access to a central database. The purchaser hosts this system and a supplier may be allowed to access the database using a designated portal. This database system stores the product and pricing information in a standard EDI format. This system does not allow for offline usability, as the system requires the supplier to physically access the database through the dedicated portal. This system also does not allow offline usability based on data formatting, as the data is not in a human readable format, but rather is configured solely for internal software data processing.

Therefore, with the existing systems using paper reminders or electronic database structures, there is not an automatic reminder system. The current systems also do not allow for efficient user access, including offline access and/or readable access from the database. As such, there exists a need for maintaining the validity of contract terms and updating contract terms prior to or upon the expiration of the contract terms.

### BRIEF DESCRIPTION OF THE DRAWINGS

FIG. 1 illustrates a block diagram of one embodiment of an apparatus for maintaining and updating product and pricing terms;

FIG. 2 illustrates a graphical representation of an exemplary embodiment of a procurement form having multiple product and pricing terms;

FIG. 3 illustrates a flow diagram of one embodiment of the operation a system for updating product and pricing terms;

FIG. 4 illustrates a block diagram of a system providing for the maintenance and update of product and pricing terms between a purchaser and a supplier;

FIG. 5 illustrates a flowchart of one embodiment of a method for updating product and pricing terms; and

FIGS. 6-17 illustrate flowcharts relating to the generation and usage of templates.

### DETAILED DESCRIPTION

A product and pricing term updating system allows for the determination and retrieval of product and pricing terms about to expire. Through the use of a processing device in conjunction with a contract database, the product and pricing terms to be updated are generated into a human readable form. The human readable form also allows for a greater degree of flexibility, such as being attachable to an electronic message and formatted for subsequent printing. Moreover, the term updating system, through the generation of a procurement form, allows for product and pricing terms to be updated from an offline connection. Therefore, a high degree of mobility is allowed through reading and usage of the procurement form outside of a direct connection to the contract database.

The product and pricing term updating system also provides an internal data input accuracy check through defined ranges for input terms. Data fields in the procurement form can have ranges to prevent accidental data entry of incorrect contract terms, thereby not only increasing the accuracy of data input but also providing a high degree of error reduction. Furthermore, using the procurement form reduces software requirements for parties to the contract. A defined platform structure, such as a commercially available browser or viewer application, eliminates extraneous and/or new software requirements for integration of the term updating system.

As described below, a product and pricing term updating system notifies a user of the expiration of product and pricing terms. Through the storage of product and pricing terms in a contract database, these terms may be easily and readily monitored based on expiration dates. Therefore, purchasers and suppliers do not need to utilize secondary tracking systems to monitor expiration dates, such as hand-written notes on calendars or notes within electronic calendars. Moreover, purchasers and suppliers do not need to then regenerate contracts with these terms to be updated. Furthermore, purchasers and suppliers do not need to dedicate time attending to data tracking and data assembly matters, which may include numerous contracts, each having a large number of contract terms. The system can access the database to retrieve product and pricing terms based on search terms including expiration dates.

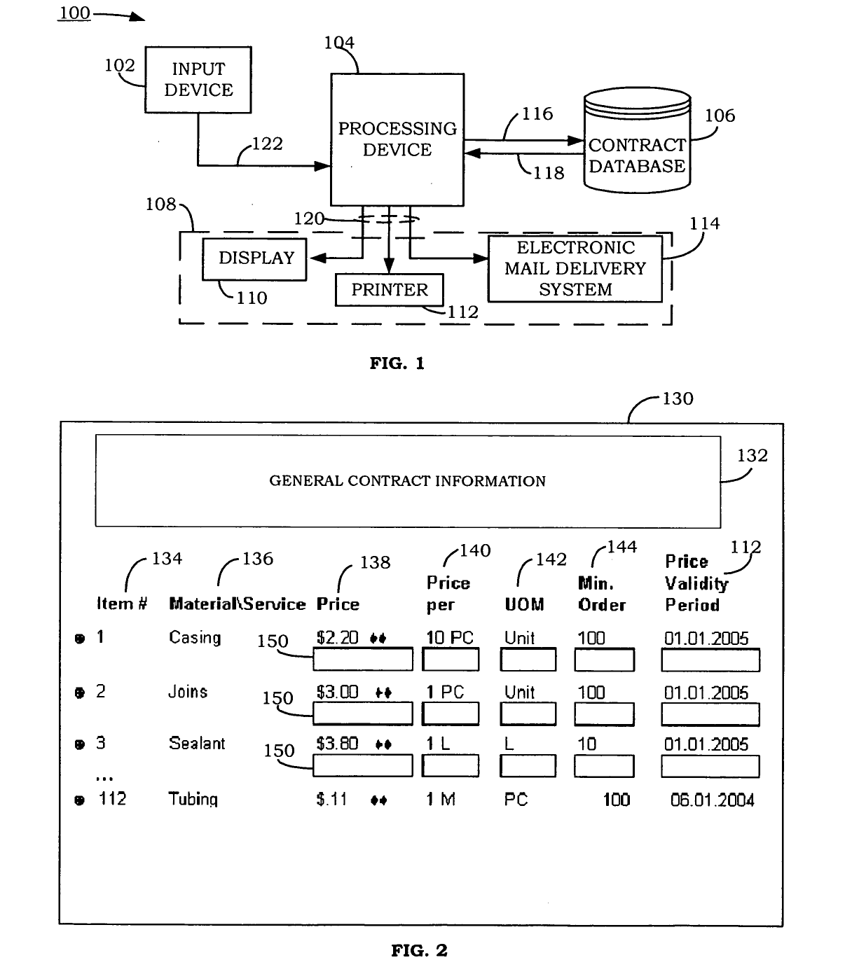

FIG. 1 illustrates a block diagram of one embodiment of an apparatus 100 for product and pricing term updates. The apparatus 100 includes an input device 102, a processing device 104, a contract database 106 and an output device 108. The input device 102 may be any suitable device capable of receiving user input or an input signal, such as, but not limited to, a physical device like a keyboard, keypad, a touch-screen or a scanner with original content recognition software or a processing device like an electronic mail delivery system including a receiving capabilities.

The processing device 104 may be, but not limited to, a single processor, a plurality of processors, a DSP, a microprocessor, an ASIC, a state machine, or any other implementation capable of processing and executing software. The term processing device should not be construed to refer exclusively to hardware capable of executing software and may implicitly include DSP hardware, ROM for storing software, RAM, and any other volatile or non-volatile storage medium.

The contract database 106 may be any suitable memory or storage location operative to store sales information including product and pricing terms or any other suitable information therein including, but not limited to, a single memory, a plurality of memory locations, shared memory, CD, DVD, ROM, RAM, EEPROM, optical storage, microcode, or any other non-volatile storage medium capable of storing information.

The output device 108 may be any suitable device capable providing an output, such as but not limited to a display 110, a printer 112 and an electronic mail delivery system 114.

In one embodiment, the processing device 104 provides data retrieval signal 116 to the contract database 106. The data retrieval signal 116 is an operative search command to retrieve expiring product and pricing terms, wherein the search command include a date or range of dates corresponding to potential expiration dates for product and pricing terms. As discussed in further detail below, the contract database 106 stores a plurality of contracts which include multiple contract terms, including among other terms product and pricing terms, these contract terms define the conditions of a contract between a purchaser and a supplier.

The contract database 106 thereupon searches data representing product and pricing terms stored therein. The product and pricing terms are defined business objects having parameters allowing for searching, wherein each product term and pricing term is a specific business object recorded and stored in the contract database. In response to the retrieval request 116, the processing device 104 receives product and pricing terms 118 within a time period of expiration.

The processing device 104 thereupon generates a procurement form 120 which is provided to the output device 108. The procurement form 120 may be any electronic formation of data fields including the product and pricing terms 118, as well as ancillary contract terms, from the contract database 106. The procurement form 120 may also include contract terms not nearing expiration, to provide a greater degree of clarity for parties seeking to update the product and pricing terms.

In one embodiment, the procurement form 120 may be provided to the display 110. The procurement form 120 is thereby viewable on the display 110. If the display 110 is a touch-screen, technologies within the display 110 may also provide functionality of the input device 102 allowing for direct user input. In another embodiment, the display 110 may work in conjunction with the input device 102, wherein the display 110 provides visual queues for data entry using the input device 102, in response to operations performed by the processing device 104. In this embodiment, data input operations using the procurement form 120 visible on the display 110 with input from the input device 102 would be in accordance with known input/output operations.

In another embodiment, the processing device 104 provides the procurement form 120 to the printer 112. Using proper printer driver technology, the processing device 104 formats the procurement form 120 to be printable using the printer 112, thereupon generating a hard-copy of the procurement form 120. In one embodiment, hand notes and revisions may be entered onto the paper form and the input device 102 may be a keyboard or keypad accepting input keystroke commands or may be a scanner using original content recognition (OCR) software to receive the product and pricing term updates.

In another embodiment, the processing device 104 provides the procurement form 120 to the electronic mail delivery system 114. The electronic mail delivery system may be any suitable system allowing for electronic communication, such as but not limited to electronic mail (email), paging, messaging systems, e.g. SMS, EMS, MMS, transmissions using wired and/or wireless transmission systems.

The processing device 104 may format the procurement form 120 to be associated with the electronic mail delivery system 114. For example, the processing device 104 may format the procurement form 120 to be in a third-party application for attachment to an electronic mail message, wherein the third-party application may be a software implementation such as a browser or viewer application. In another example, the processing device 104 may format the procurement form 120 in any format consistent with protocols of the electronic mail delivery system 114 such that the procurement form 120 is contained within an electronic mail message.

FIG. 1 illustrates the generation of the procurement form 120 and delivery of the procurement form 120, including product and pricing terms to be updated, to the output device 108. FIG. 2 illustrates an exemplary embodiment of a procurement form 130 including a header 132 displaying purchaser/supplier product and pricing information. The header 132 may include information for a specific contract or may be information relating to multiple contracts between similar parties, wherein the product and pricing information relates across multiple contracts. Furthermore, the header 132 may include any suitable information, such as invoice or contract reference numbers and/or the names and address of parties to the contract. In one exemplary embodiment, the form 130 includes data assimilated in tabular form including designated columns with rows of corresponding information.

The form 130 provides information in a human readable format instead of the previous techniques which provided data encoded using internal software encoding. For example, columns may include product and pricing terms, such as item numbers 134, material or service descriptions 136, price terms 138, price per unit terms 140, units of measurement terms 142, minimum order terms 144 and validity period terms 146. In a typical embodiment, the term validity period 146 applies to all contract terms, such as elements 138 through 144. In another embodiment, different validity period terms 146 may apply to different contract terms.

In the exemplary procurement form 130, items numbered 1, 2 and 3 have validity periods 146 terminating on the date Jan. 01, 2005. Assuming that present date is within a predefined time interval of the date Jan. 01, 2005, such as within 30 days, 60 days or 90 days for example, the procurement form 130 includes update fields 150 for the input of new terms. In this embodiment, the presence of the update fields 150 indicate the product and pricing terms are to be updated. Excluding the update field, such as illustrated with item 112, may indicate the validity period is not near expiration. In another embodiment, the procurement form 130 may contain update fields 150 for all terms and the users can ignore update fields 150 for non-expiration terms.

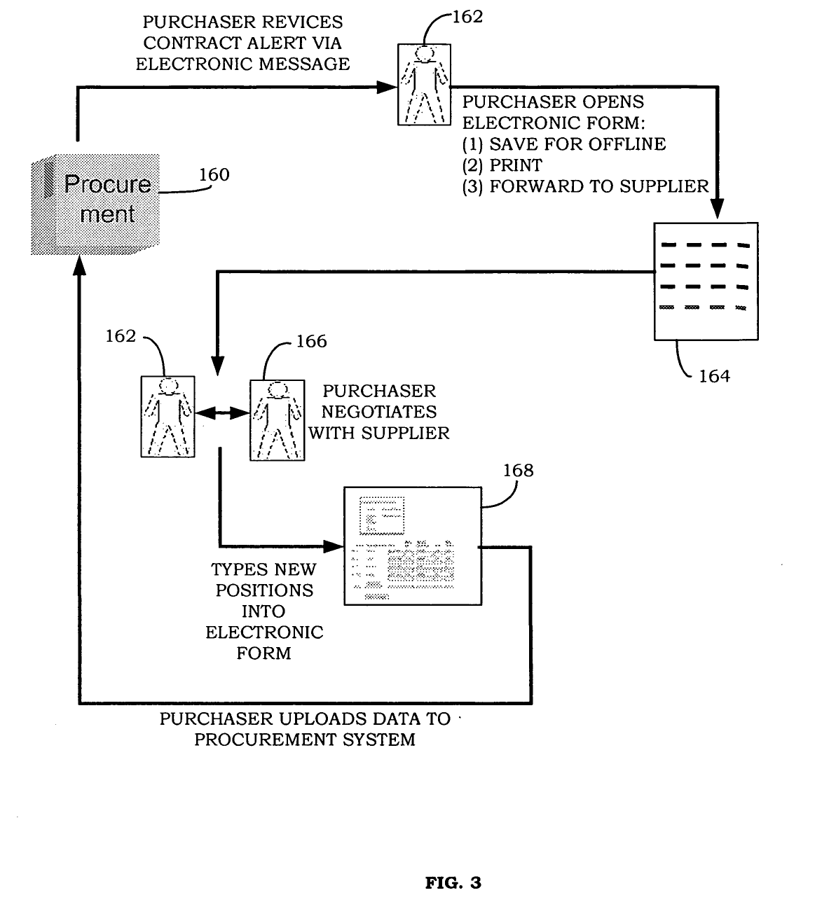

FIG. 3 illustrates a representative diagram of one embodiment of the process of updating product and pricing terms. A procurement system 160 receives an input command from a purchaser 162. In one embodiment, the purchaser 162 searches the procurement system, including contract database 106 of FIG. 1, to find product and pricing information for a particular supplier. In another embodiment, the purchaser 162 searches the procurement system 160 for all materials from a particular supplier based on a noted expiration date. The procurement system 160 thereupon provides a list 164 of product and pricing terms already expired or that will expire prior to the given expiration date.

The purchaser 162 may, in one embodiment, manually add other items to the list 164 to generate list 166, wherein these other items may include product and pricing terms. In one embodiment, the purchaser 162 may enter product and pricing terms or may simply enter the product and pricing term categories so that a subsequent supplier may enter the actual values for the terms.

The purchaser 162 then generates a procurement form 168 from the list 166. The processing device 104 of the purchasing system 100 may generate this procurement form 168, as discussed above in FIG. 1. In one embodiment, the purchaser 162 sends the procurement form 168 to a supplier 170 using an electronic mail message 172. The supplier may then manually enter product and pricing terms in the procurement form 168 and return the procurement form 168 back to the purchaser using the electronic mail delivery system. In another embodiment, the purchaser and supplier negotiate in person, via telephone, via exchanged messages or using any other technique. The purchaser 162 then fills out the procurement form 168 during or after negotiations.

Upon agreement of product and pricing terms, the purchaser 162 then uploads the product and pricing terms into the procurement system 160. The procurement system 160 thereupon updates the product and pricing information accordingly. In one embodiment, verification of input information may be verified using electronic signatures, encryption techniques or any other suitable means to authenticate the purchaser 162 and supplier 170 agreeing to the product and pricing terms. Furthermore, standard time stamp techniques may be utilized to verify and insure the procurement system 160 includes the most current and accurate product and pricing information. Consistent with product and pricing information, other contract terms may also be negotiated and included within the procurement form and subsequently updated within the procurement system 160.

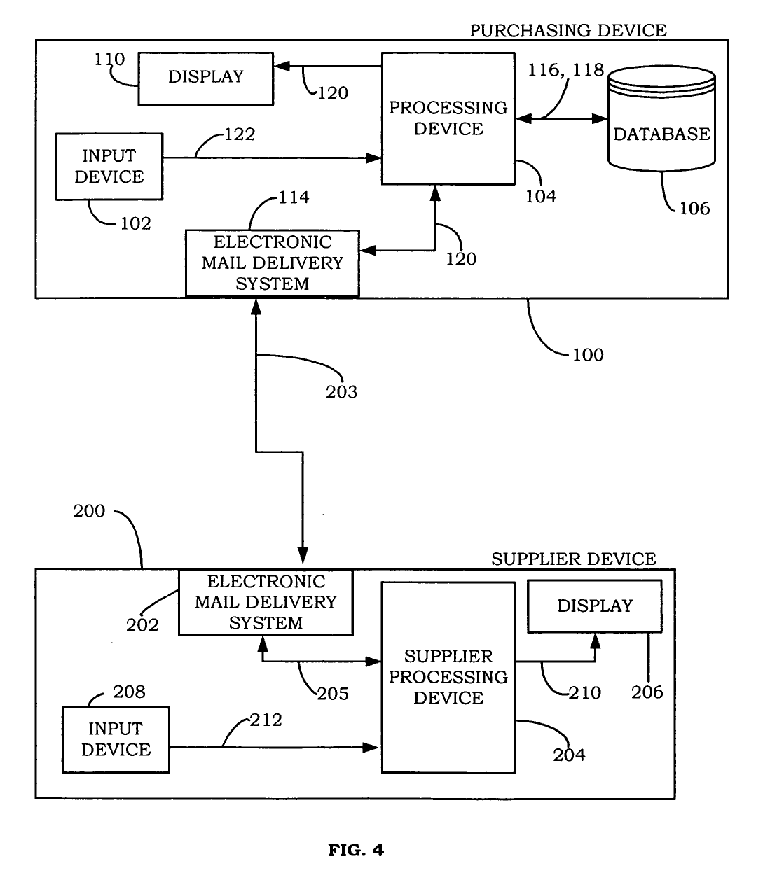

FIG. 4 illustrates a block diagram of a system allowing for product and pricing term updates between a purchasing device 100, as described above in FIG. 1 and a supplier device 200. The purchasing device 100 includes the input device 102, the processing device 104, the database 106, the display 110 and the electronic mail delivery system 114.

The supplier device 200 includes an electronic mail delivery system 202, a supplier processing device 204, a display 206 and an input device 208. The electronic mail delivery system 202 may be any suitable system similar to the system 114 of the purchasing device 100 capable of receiving and transmitting electronic communications, including but not limited to a processing device executing operating instructions to performed the functions of electronic communication.

The purchasing device 100 is in operative communication with the supplier device 200 using any suitable communication technique, including but not limited to wired or wireless connections across public and/or proprietary networks. In one embodiment, the electronic mail delivery system 202 is operative to receive the procurement form in an electronic transmission from the electronic delivery system 114 of the purchasing device 100.

The supplier processing device 204 is operative to receive either the procurement form or the electronic transmission and extract the procurement form therefrom. The supplier processing device 204 provides an output 210 to the display 206 so that an operator using the supplier device 200, typically the supplier or the supplier and purchaser in a negotiation environment, may visually review the procurement form.

Concurrent with viewing the procurement form, the supplier device 200 is operative to receive input commands in the input device 208 and provide input signals 212 to the supplier processing device 204. In one embodiment, the input device 208 may be a keyboard or keypad operative to receive keystrokes and the input signal 212 represents these inputs. In another embodiment, the input device 208 may be a touch-screen associated with the display 206. The supplier processing device 204 receives the input signal 212, wherein the input information relates to negotiated contract terms in the procurement form.

Upon completion of negotiating or re-negotiating the product and pricing terms, the supplier processing device 204 is operative to provide the updated product and pricing terms back to the electronic mail delivery system 202, wherein the updated product and pricing terms are the agreed upon new contract terms relating to both product information and pricing information. Thereupon, the updated product and pricing terms are provided to the purchasing device 100 through the electronic mail delivery system 114. These updated product and pricing terms may then be provided back to the processing device 104 and updated within the contract database 106.

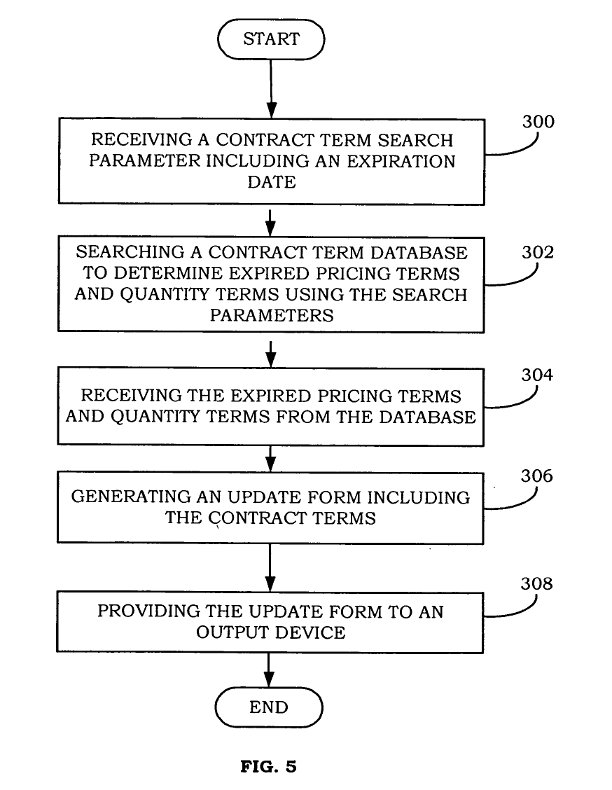

FIG. 5 illustrates a flowchart of the steps one embodiment of a method for determining product and pricing terms needing to be updated. The method begins, step 300, by receiving a search request having search parameters. The search parameters may include a request for search and retrieval of product and pricing information for a supplier, a contract, a product, a product or pricing term expiration date, or any other suitable information.

The next step, step 302, is searching a contract database to determine product and pricing terms using the search parameters. In one embodiment, the search is conducted based on an expiration date included within the search parameters. This step may be performed by examining specific business objects having associated information relating to the contracts and contract term expiration dates. As illustrated above in FIG. 2, the terms may have specific expiration dates, but an expiration date may further be applicable to the contract itself, thereby searching multiple contracts and/or specific contract terms, and/or product and pricing terms, in the database.

The next step, step 304, is receiving the expired product and pricing terms from the contract database. In one embodiment, the contract term database may provide the full contract including all contract terms to the processing device. The data structure of the contract and contract terms, including product and pricing terms, may be consistent with a business object readable by the processing device. Therefore, the next step, step 306, is generating a procurement form including the product and pricing terms. The procurement form, such as illustrated in FIG. 2, converts the contract terms into a human readable format by creating a tabular display of information.

In this embodiment, the next step, step 308, is providing the procurement form to an output device. In one embodiment, the output device may be an electronic mail messaging system such that the procurement form is attached to or embedded within an electronic mail message. The output device may also be a printer allowing for printing of the human readable procurement form. As such, in this embodiment, the method is complete.

In other embodiments, the method described above in FIG. 5 may further include determining the expired product and pricing terms by examining the expiration dates of the product and pricing terms. As noted, the expired product and pricing terms do not exclusively refer to product and pricing terms currently expired but may also include terms nearing expiration, such as within an upcoming period of time. The determination may be performed using any suitable technique including comparing expiration dates of the product and pricing terms with an expiration date or range of expiration dates.

Moreover, prior to providing the procurement form using the electronic mail message, the procurement form may be converted to be included within or attachable to the electronic mail message. This step may be performed using data manipulation operations to convert the procurement form into a software application format usable with the electronic mail delivery system, such as a commercially available third party software application.

In other embodiment, updated product and pricing terms may be received via the electronic mail delivery system. The updated product and pricing terms may be examined for errors, such as determining if the values are within a prescribed value range. The updated product and pricing terms may then replace the expired terms in the contract database, thereby providing current contracts with current product and pricing terms.

As such, product and pricing term updates may be achieved through the automatic receipt of the procurement form. The procurement form includes expired product and pricing terms and the procurement form is in a human readable form associated with an electronic message. The procurement form is interactive, allowing direct user input of updated terms and through the interactivity, allowing seamless integration of the updated product and pricing terms into the contract database.

In conjunction with product and pricing updates, the information may be portrayed within standardized formats, including templates. The use of templates reduce confusion between multiple users through the standardization of not only information input, but also the display of acquired information. Generating templates and subsequent interactive forms allows a user to customize data input and output.

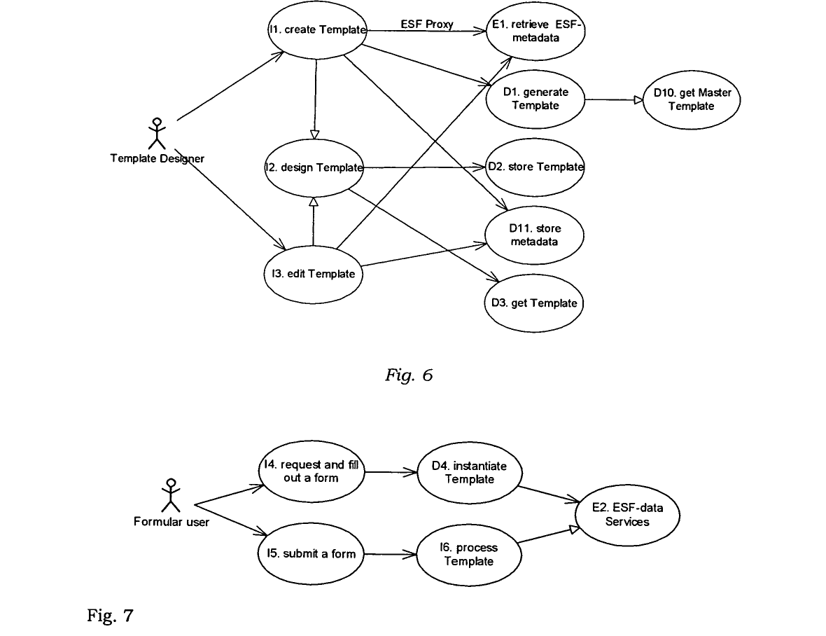

As illustrated in FIG. 6, the process of designing a template includes data connections to Business objects. So in a first step the template designer choose which Business Object is involved and selects the appropriate fields. When an ESF compound-service is used, complex tree-view like structure are also used.

After this selection the template is pre-generated based on a master template. This master template ensures that some basic formatting, styles, header- and footer texts are in the new template. The selected ESF-Fields are pre-generated into the template.

The template designer decides into which output-media to edit and store the template, such as any suitable software application allowing for data entry and review. The template designer also lays out the template using any suitable design tool. In one embodiment, the above mentioned selection of Business object-Fields may be disposed within a design-tool, such as an add-in.

If the template designer wants to edit a template, he also has the possibility to change the selected metadata of the ESF-Business object. The template designer may see what fields are related to the templates, which are not and which are new since the last edit session.

In other embodiments, various interfaces may be utilized to allow for the generation and the templates. For example, one embodiment may use Inbound processing for maintaining business objects. (e.g. Create/Change sales orders by using of the Purchase message.) Furthermore, in one embodiment, the templates support versioning, allowing a user to entry various levels of information in various versions.

As illustrated in FIG. 7, a user starts the process to fill out and submit a form, including within a control-center or in a business context (application). The template is instantiated, in one embodiment the data is automatically retrieved from the ESF-data services through the corresponding ESF-binding and the business context providing the key to the data.

After the user submits the form (online or offline), the template is processed and the corresponding Update or Create-Methods of the ESF are called. It is also possible that the “request” is not active, that means that the form is sent to the user across an electronic mail delivery system.

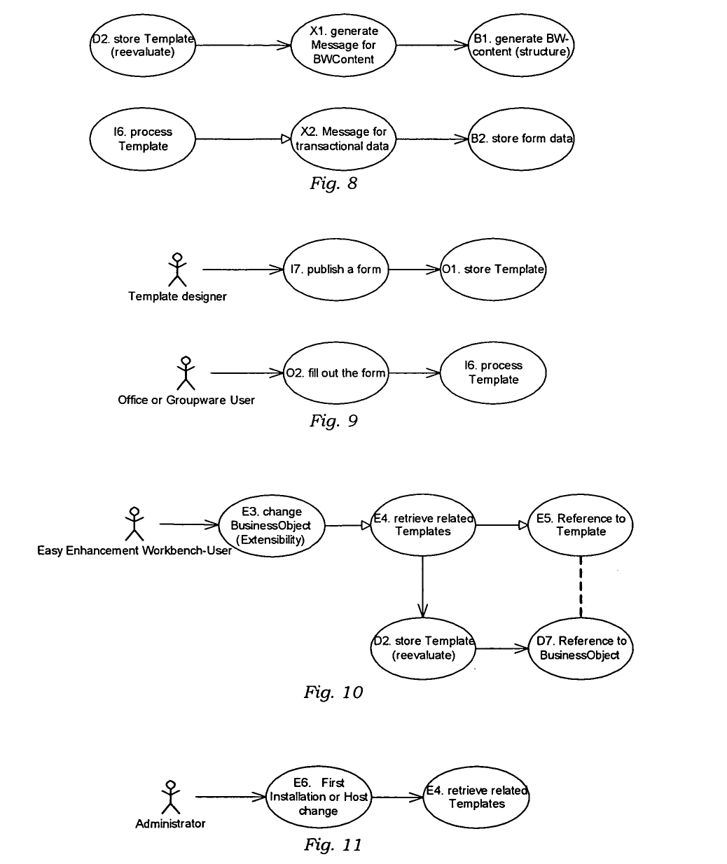

As illustrated in FIG. 8, in another embodiment, the Interactive Form may be coupled with a BI connectivity, realized over XI. The structure of the form data leads to a generation of an XI-component, and which is propagated to the BI-system with the creation of the ODS-Tables. If a form is submitted by a user the data of the form is sent as an XI-Message to the BI-system, where the data is stored in the designated tables.

In another embodiment, upon receipt of the data, the system allows a BI-User to analyze the submitted data. An application for that scenario may be a survey application. BI uses the data of both objects, the business object as the leading object and the form assigned to the business object. Therefore, at least in the BI a link is used between both for reporting issues (e.g. BO carries the partner and date/time information and the form all others.)

As illustrated in FIG. 9, in addition to the personalized invocation it is possible to publish a form in a “un-instantiated” form on a desired location (network folder, groupware folder, etc.). The form will be instantiated when a user opens the form from that location. The authentication of the user works by a certificate or its windows user-login.

As illustrated in FIG. 10, it is possible to extend the structure of a Business Object. Therefore it is possible to retrieve all related Templates for a specified business object, so a list could be displayed to a Easy Enhancement Workbench (EEW) User. The EEW User decides if the template also has to be extended. Data relevant for the where-used index should be stored for all EEW user interface objects (such as UI, forms, operational reports) in the same way.

The EEW makes the extension of ESI data types with new fields (elements) possible, by choreographing the necessary steps. The EEW should call for the Business Object [Nodes] a where-uses index for print forms, operational report and UIs, in order to be able to navigate to the extension of these.

Similar to the Extend Business Object scenario, FIG. 11 illustrated another embodiment wherein it is necessary to change templates on installation time because templates might have embed URLs to locate the backend-system. The same issue pops up, if the host or host-group is changed to another physical or logically machine. All templates have to do be changed based on the host-information. It is possible that different properties might contain URLs, perhaps they have to be marked as “host-dependant properties”.

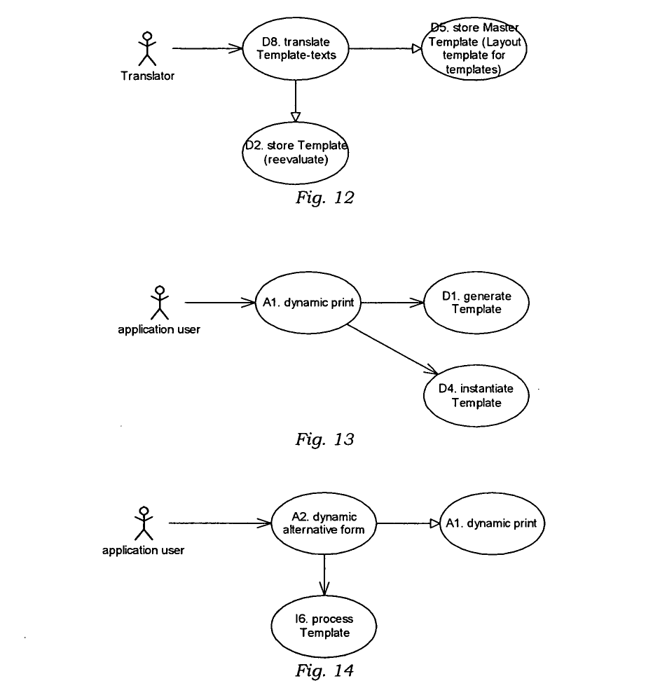

FIG. 12 illustrates another embodiment where template texts have to be connected to a translation process. This applies to template and master template texts. In one embodiment, the texts are stored as metadata and linked as appropriate references. It could be helpful to see the text (description) of the field whenever you want to drag fields from the field panel into the layout area. A user reads the field descriptions in the form during the run time, in one embodiment.

FIG. 13 illustrates that some dynamic content objects make it necessary that templates are generated on the fly from an ABAP or Java application. The process are not different from the API point of view from “Design a Template” and parts of “Fill out and submit a form.” (Request a form), only that all form fields are set to read-only, cause in the “Dynamic Interactive Form”-scenario the same template should be used. The data basis for the generation may be accessible via ESF.

FIG. 14 illustrates another embodiment similar to a “Dynamic Print”, only that the dynamically created template is used as an interactive form.

FIG. 15 illustrates one embodiment of a spreadsheet integration (access to specific doc-properties before rendering). An application should be able to store and retrieve Templates. Also it should be possible to change properties of the document (like custom properties) before an instance is rendered. This scenario is based on a Spreadsheet-integration-feature.

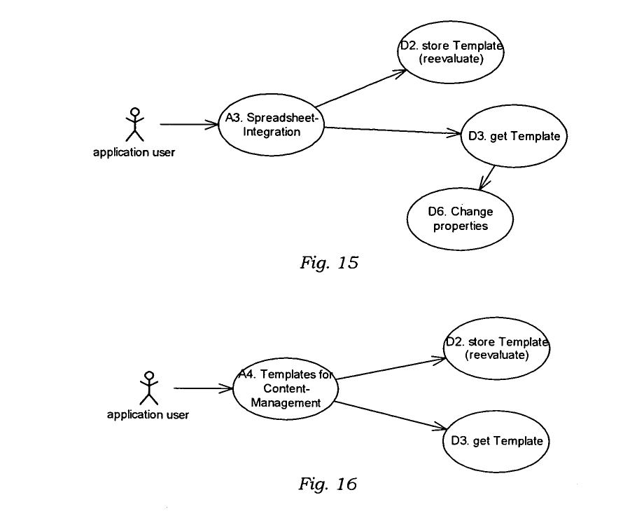

FIG. 16 illustrates an embodiment of a Template-Store for Content-Management. In this embodiment, documents may be stored in a central system. In one embodiment, the templates for document-creation-processes can be stored with certain criteria (language, user, etc,) and be retrieved with this criteria. It is also desirable that a list of templates can be retrieved without the binary template itself, regarding a template selection dialog.

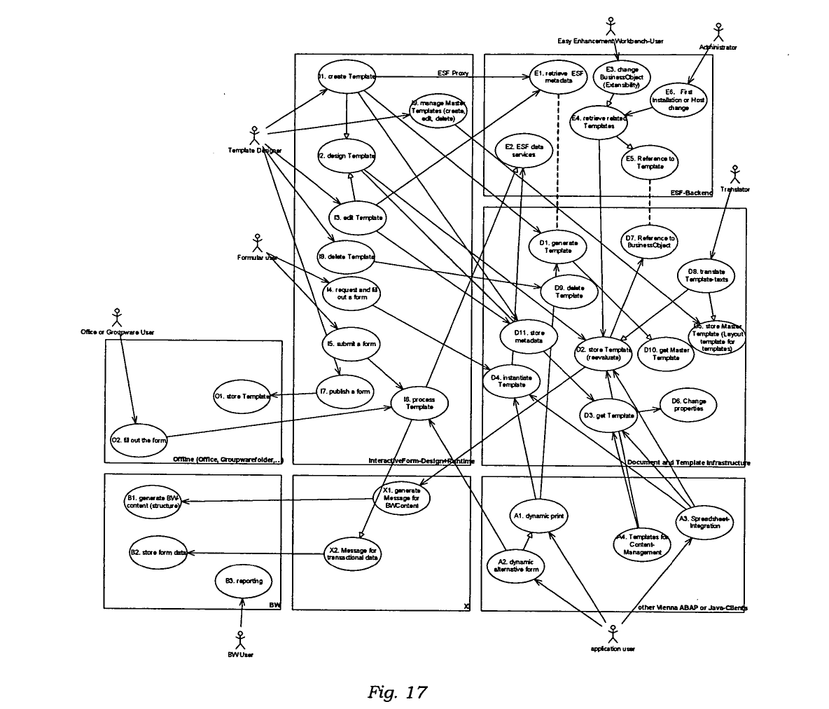

Thereby, various techniques may be used to acquire and integrate the templates into the above-described product and pricing system. In one embodiment, a general overview of various techniques is illustrated in FIG. 17.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should be understood that there exists implementations of other variations and modifications of the invention and its various aspects, as may be readily apparent to those of ordinary skill in the art, and that the invention is not limited by specific embodiments described herein. It is therefore contemplated to cover any and all modifications, variations or equivalents that fall within the scope of the basic underlying principals disclosed and claimed herein.

What is claimed is:

1. An apparatus for product and pricing term updates, the apparatus comprising:
a contract database storing data representing a plurality of sales contracts including product and pricing terms, each of the product and pricing terms having an expiration date;
a processing device in operative communication with the contract database;
an output device in operative communication with the processing device; and
the processing device, in response to executable instructions, operative to:
retrieve product and pricing terms from the contract database based on a search request that includes a search date;
generate a procurement form including the product and pricing terms to be updated
transfer the procurement form to be provideable to another computing system.

2. The apparatus of claim 1, the processing device further operative to:
determine the product and pricing terms to be retrieved for being updated based on the expiration dates of the product and pricing terms.

3. The apparatus of claim 1 wherein the output device is a printer, the processing device further operative to:
convert the procurement form into a printable format; and
provide the procurement form to the printer.

4. The apparatus of claim 1 wherein the output device is an electronic mail delivery system, the processing device further operative to:
convert the procurement form into a transmittable format; and
provide the procurement form to the electronic mail delivery system.

5. The apparatus of claim 1 further comprising:
an input device operative to receive updated product and pricing terms; and
the processing device operative to integrate the updated product and pricing terms within the contract database.

6. The apparatus of claim 5 wherein the input device includes the electronic mail delivery system and the updated product and pricing terms are associated with an electronic message such that at least one of: the processing device and the electronic mail processing system, is operative to read the electronic message and extract the updated product and pricing terms therefrom.

7. The apparatus of claim 5 wherein the input device includes a data entry device such that the update product and pricing terms are received from the data entry device.

8. The apparatus of claim 5 wherein the processing device is further operative to:
verify that the updated product and pricing terms are within predefined term guidelines.

9. A method for updating product and pricing terms, the method comprising:
receiving a search request having search parameters;
searching a contract database to determine expired product and pricing terms using the search parameters;
receiving data representing the expired product and pricing terms from the contract database;
generating a procurement form including the product and pricing terms data; and
providing the procurement form to an output device.

10. The method of claim 9 further comprising:
determining the expired product and pricing terms by examining expiration dates of each of the product and pricing terms.

11. The method of claim 9, wherein the output device is a printing device, the method further comprising:
prior to providing the procurement form to the output device, converting the procurement form into a printable format.

12. The method of claim 9, wherein the output device is an electronic mail delivery system, the method further comprising:
prior to providing the procurement form to the output device, converting the procurement form to be transmittable using the electronic mail delivery system.

13. The method of claim 9 further comprising:
receiving updated product and pricing terms; and
replacing the updated product and pricing terms in the contract database.

14. The method of claim 13 wherein the updated product and pricing terms are received through an electronic mail delivery system and the updated product and pricing terms are associated with an electronic message such that the electronic message is read and the updated product and pricing terms are extracted therefrom.

15. The method of claim 13 wherein the updated product and pricing terms are received from a data entry device.

16. The method of claim 13 further comprising:
verifying the updated product and pricing terms are within predefined term guidelines.

17. A computer readable medium storing thereon programming instructions that when executed, cause an executing device to:
receive a search request having search parameters;
search a contract database to determine expired product and pricing terms using the search parameters;
receive data representing the expired product and pricing terms from the contract database;
generate a procurement form including the product and pricing terms data; and
provide the procurement form to an output device.

18. The computer readable medium of claim 17 further comprising instructions that cause the executing device to convert the procurement form to be transmittable using an electronic mail delivery system.

19. The computer readable medium of claim 17 further comprising instructions that cause the executing device to convert the procurement form into a printable format.

20. The computer readable medium of claim 17 further comprising instructions that cause the executing device to:
receive updated product and pricing terms; and
replace the updated product and pricing terms in the contract database.

21. The computer readable medium of claim 17 further comprising instructions that cause the executing device to verify the updated product and pricing terms are within predefined term guidelines.

22. A system for electronic product and pricing updates, the system comprising:
a purchasing device including:
a contract database storing data representing a plurality of sales contracts including product and pricing terms, each of the product and pricing terms having an expiration date;
a processing device in operative communication with the contract database;
an output device in operative communication with the processing device; and
the processing device, in response to executable instructions, operative to:
retrieve product and pricing terms from the contract database based on search parameters;
generate a procurement form including the product and pricing terms to be updated; and
transfer the procurement form to another computing system; and
a supplier device including:
a supplier processing device, in response to executable instructions, operative to:
receive the procurement form from the output device of the purchasing device.

23. The system of claim 22 further comprising:
the purchasing device processing device further operative to determine the product and pricing terms to be retrieved for being updated based on at least the expiration dates of each of the product and pricing terms.

24. The system of claim 23 wherein the output device is an electronic mail delivery system, the purchasing processing device further operative to:
convert the procurement form into a transmittable format; and
provide the procurement form to the electronic mail delivery system.

25. The system of claim 24 wherein the supplier device is further operative to:
receive the procurement form from the electronic mail delivery system; and
receive a plurality of updated product and pricing terms from an input device.

26. The system of claim 25 wherein the supplier device is further operative to transmit the plurality of updated product and pricing terms to the purchasing device.

29. The system of claim 27 wherein the purchasing device further includes an input device operative to receive the updated product and pricing terms and the purchasing device processing device operative to integrate the updated product and pricing terms within the contract database.
